(19) United States
(12) Patent Application Publication
(10) Pub. No.: US 2004/0206863 A1
(43) Pub. Date: Oct. 21, 2004

(54) Balanced camera tripod head

(76) Inventor: Erwin Tillschneider, Pfaffenhofen (DE)

Correspondence Address: Rocco S Barrese, Dilworth & Barrese, 333 Earle Ovington Boulevard, Uniondale, NY, 11553, US

(21) Appl. No.: 10/250,660

(22) PCT Filed: Jan. 4, 2002
(86) PCT No.: PCT/EP02/00046

(30) Foreign Application Priority Data
Jan. 5, 2001 (DE) 101 00 316.1
Dec. 28, 2001 (DE) 101 64 368.3

(51) Int. Cl. F16M 11/02

(52) U.S. Cl. 248/177.1

(57) ABSTRACT

The invention relates to an balanced camera tripod head that comprises: a base element (4); a tiltable arrangement (2) that is linked with the base element (4) so as to be rotatable about a tilt axis (N) and that can be rigidly linked with a camera system; and a device for compensating for a tilt moment that occurs when the head is tilted which comprises at least one spiral spring (3) that rests with its one end on the base element (4). The device for compensating for the tilt moment comprises a follower device (5) that is mounted on the tiltable arrangement (2) at a distance to the tilt axis (N) and that deflects the spiral spring (3) when the camera system is tilted. Said spiral spring (3) exerts a substantially sinusoidal restoring moment on the tiltable arrangement and thus on the camera system.

### TECHNICAL FIELD

The present invention relates to a camera tripod head in accordance with the preamble of claim 1 and claim 7.

Cameras that cannot be handheld—for example, because of their weight or size or because of special requirements in terms of smooth camera movement—rest on a tripod or pedestal. The camera is attached to a tripod head that is rotatable about a horizontal axis (tilt axis) and a vertical axis (swivel axis) to enable the cameraman to follow moving objects with the camera's object lens. (In the following, solely the term “camera tripod” will be used; however, the descriptions apply equally to camera pedestals). When tilting the camera, i.e. when rotating the tripod head about its tilt axis, the distance between the camera's centre of gravity from this axis (height of centre of gravity) together with the camera's force of gravity, generate a turning moment about the tilt axis that depends on the tilt angle.

The weight compensation device should permit force-free tilting of the camera by compensating for this tilt moment. It is necessary for this weight compensation to be rapidly and easily adjustable for different weights and different heights of the centre of gravity, because of the immediate change in the load moment when attaching different cameras or accessories such as teleprompters etc.

In addition, the weight compensation should hold the camera directly in any tilt position without any subsequent movement, within a tilt range of at least ± 90°, to enable the entire spatial field of view to be covered when tilting the camera.

In order to make gentle tilt movements possible, the tripod head should in addition have a damping device independent of the weight compensation, and as far as possible also adjustable and friction-free.

### PRIOR ART

Known camera tripod heads have for example a hydraulic damping element with adjustable rotation resistance to damp the tilt movement, as described in German patent 24 57 267. German patent P 26 57 692 also describes a damping device for tripod heads.

As regards the weight compensation, there is for example known tilt moment compensation with several rubber disc torsion springs arranged one after the other on the tilt axis (DE 30 26 379). Here, the weight compensation can be adapted by engaging or disengaging individual springs. Tilt moment compensation through compression or tension springs arranged serially is also known.

A weight compensating device for an object swivelling about a pitch axis is known from DE 39 08 682 A1. A restoring moment acts with the help of a spiral spring arrangement via a lever arm on the pitch axis. In order to extend the pitch range and achieve the ideal turning moment compensation, the compensating device exhibits a step-down gear where the axis of the input shaft is the pitch axis and where the spiral spring arrangement acts via a lever arm on the output shaft.

### DESCRIPTION OF THE INVENTION

The present invention is based on the task of creating a camera tripod head with a device for compensating for a weight moment that occurs during this tilt movement, compensating for the tilt moment as accurately as possible and nevertheless capable of compact execution.

The invention addresses this task through a tripod head with the features listed in Claim 1 as well as through a tripod head with the features listed in Claim 7.

According to claim 1, the device contains a follower device for tilt moment compensation that is attached to a tiltable arrangement at a position some distance from the tilt axis, and that deflects the spiral springs in the direction of tilt when the camera system is tilted. The spiral spring applies an essentially sinusoidal restoring moment via the follower device to the tiltable arrangement and thus on the camera system. According to claim 7, in contrast, at least one spiral spring is deflected by the follower device against the direction of tilt.

The distance between the tilt axis and the follower device's contact point with the spiral spring effectively forms a lever arm for the restoring moment, such that the spiral spring applies a restoring moment to the camera system. The spiral spring's restoring force depends on the camera's tilt angle, and the generated restoring moment is sinusoidal.

This offers the advantage that the course of the compensating moment corresponds to that of the tilt moment when tilting the camera across the entire tilt range of at least ± 90°, such that the camera can be tilted at large tilt angles with little force just as at small tilt angles and even at large tilt angles remains stationary in any desired position without subsequent movement. At the same time the spiral spring can be of a compact design and integrated into the tripod head.

Advantageous embodiments of the tripod head as per Claim 1 derive from the associated sub-claims.

Thus the follower device is preferably attached to the tiltable arrangement so as to be rotatable, with the relevant rotational axis lying parallel to the tilt axis. The effect of this relative rotation is that the camera's tilt movement is not transmitted completely to the spiral springs. For example, with a 90° tilt angle of the camera and hence also of the tiltable arrangement, an angle is formed between the follower device and the tiltable arrangement, with the effect that the deflection of the spiral springs is considerably less than 90°. In this way, the tilt range of ± 90°, especially desirable for camera systems, can be ensured without the spiral springs under a strain that exceeds the maximum permissible value.

To this end it is especially advantageous if the follower device moves relative to the spiral spring when the camera is tilted.

In an advantageous, stable embodiment, the tiltable arrangement has at least one tilt leg, which at its end is preferably connected to a carrier plate, on which the camera system can be mounted. A particularly stable embodiment is achieved by using at least two tilt legs, arranged in parallel to each other.

One option for embodiment of the spiral springs consists of providing a spiral spring plate. By suitably choosing the geometric form of the spiral spring plate (rectangle, triangle, trapezoid etc), the characteristic curve of the sinusoidal restoring moment can be optimised. The behaviour of the spiral spring plate can also be suitably controlled by cut-outs, created e.g. by punching out holes in the material. It is advantageous to have the deflection of the spiral spring at right angles to its plane.

However, it is also feasible to use other forms of spiral springs such as e.g. spring rods, which can be designed in cylindrical, conical, hollow form etc.

In one advantageous embodiment, the follower device consists of at least one carrier element which is connected to the tilt leg so as to be rotatable, and a follower that deflects the spiral spring. It is also possible to provide two or more followers, which then preferably lie parallel to the tilt axis. For example, one follower is then arranged in the direction of tilt in front of the spiral spring and a second follower behind the spiral sprint, so that depending on the direction of tilt, one or the other of the followers deflects the spiral spring. These followers can, for example, be designed as rods.

In order to minimise as far as possible the friction losses in transmitting the tilt movement from the follower device to the spiral springs, it is advantageous to provide friction-reducing elements at the follower device, e.g. in the form of rollers or ball bearings. The smaller the friction between a spiral spring and the carrier axle, the smaller the “pull-away effect” that occurs at the start of a tilt movement.

In another embodiment of the invention's camera tripod head, several spiral springs are provided and each follower is placed between two spiral springs. Thus, followers and spiral springs are arranged so as to alternate with each other.

A particularly compact embodiment of the invention's camera head can be achieved by using a spring stack instead of an individual spiral spring. In the case of several spiral spring stacks, the spiral spring stacks and the followers are arranged alternately at right angles to the tilt axis. Here, the individual springs in the spring stacks are relatively thin, as a result of which they can be deflected through a relatively large distance for a given length, until their maximum permissible strain is reached. Thus, the thinner a spiral spring is, the shorter it can be chosen to be when a particular maximum deflection needs to be achieved. In order nonetheless to achieve a satisfactory restoring force, these thin, short springs are bundled together into stacks, in which they can move relative to each other. The restoring forces of the short, thin springs then add together to give the stack's overall restoring force, with the short physical length being preserved. However, together with the number of springs in the stack, the number of surfaces in contact also increases and with them the friction losses. Therefore, a lubricant is preferably present between the spring plates in the stack. In turn, as a result of reducing the friction, the “pull-away effect” is also minimised as well as the hysteresis that occurs when the springs are deformed.

Using spring stacks has the additional advantage that a single spring breaking does not have the same serious effect as would be the case when using individual springs.

In order to adjust the weight compensating device to different camera weights and centre of gravity heights, an adjusting device is preferably provided to modify the spiral springs' effective length, so they deform elastically only over part of their length when bending and not over the entire length. It is also feasible to implement a dynamic modification of the spring's effective length, with the spring's characteristic curve thereby being adjusted for special requirements. The restoring moment equation contains the third power of the length of the spring.

Accordingly, the stiffness of the spiral springs in the invention's camera tripod head is adjusted to the weight of the camera currently attached to the tripod head, after which its value follows a course that corresponds exactly to that of the camera weight's moment when tilted about the tilt axis: when the camera's centre of mass lies exactly vertically above the tilt axis, the spring generates no turning moment. As the camera is tilted away from its rest position, the tilt moment generated by the camera's weight increases sinusoidally with increasing tilt angle, and at the same time the compensating moment generated by the spiral spring also increases sinusoidally. Thus, at any tilt angle, the tilt moment is compensated by a counter-moment of exactly the same magnitude, such that the camera is held in equilibrium at any tilted position. The cameraman only needs to apply a negligible force to tilt the camera, and the camera remains stationary at any tilt angle.

In an advantageous embodiment of the invention's camera tripod head, the stiffness of the spiral springs is continuously adjustable. Thus, the stiffness can be adjusted precisely for cameras of arbitrary weight and arbitrary centre of gravity height; commonly-used cameras including accessories, can have a weight of up to 150 kg and a centre of gravity height of up to 50 cm. In the case of teleprompters and other such accessories that can also be mounted on the invention's camera tripod head, the weights and lever ratios may differ from the above; the weight moment generated by such attachments can also be compensated for by the invention's weight compensating device.

Furthermore, the distance between the tilt axis and the connecting point of the follower device to the tiltable arrangement, i.e. the effective lever arm of the restoring moment, can also be designed to be adjustable. The restoring moment's sinusoidal characteristic curve can be optimised by shortening or lengthening this lever arm. Nonetheless, it is equally possible to determine the suitable lever arm once and for all and not to design it to be adjustable.

In order to utilise the spring's material as efficiently as possible, it is advantageous to strain the spiral springs approximately up to their permissible limit when the camera's tilt angle is 90°.

The material used for the spiral springs can be e.g. carbon fibres, steel or glass fibres or also a combination of these or other materials. In addition, the spiral springs can also be made in sandwich form.

In addition, it is advantageous to arrange the spiral springs relative to the base element and the follower device in such a way that a small pre-tensioning force acts on the springs when the tilt angle is 0°. This prevents free play in the rest position of 0°.

As mentioned above, in a further advantageous embodiment the invention's camera tripod head also possesses a device for damping the tilt movement.

Finally, the spiral spring can be designed to be hollow or solid or a combination of at least one hollow and at least one solid body. In the case of several spiral springs or of spiral spring stacks, both hollow and solid bodies can be present simultaneously. Furthermore, the spiral springs can have any suitable geometric shape, for example also be of cylindrical form.

Advantageous embodiments of the camera tripod head as per patent claim 7 also result from the associated sub-claims.

In particular, two spiral springs can be provided which at a tilt angle of 0° are arranged at equal angles as mirror images of each other relative to a plane running vertically through the tilt axis. At positive tilt angles and a suitable geometric arrangement of the spiral springs, one of the springs is deflected more strongly against the tilt direction and the other—less strongly in the tilt direction. The situation is reversed at negative tilt angles.

However, it is also feasible to have only one single spiral spring that is clamped at one of its ends. The follower device is then so located relative to the spiral spring, that it can move along the spring in the latter's longitudinal direction and deflect the spring both at positive and negative tilt angles of the camera.

In addition, the follower device can have a carrier rod rigidly attached to the tiltable arrangement. When the camera is tilted, the carrier rod moves relative to at least one spiral spring. Therefore it is advantageous to design the carrier rod spring. Therefore it is advantageous to design the carrier rod so as to minimise the friction between the latter and the spring. This can be achieved by the carrier rod having a circular cross-section and as smooth a surface as possible.

Alternatively, the carrier rod can be rotatable about its longitudinal axis relative to the tiltable arrangement, which creates an additional degree of freedom between the follower device and at least one spiral spring.

In addition to the carrier rod, it can also have a sleeve so designed as to rotate around this carrier rod and to roll across at least one spiral spring when the camera system is tilted. In this case too, the carrier rod has a circular cross-section. The rolling sleeve facilitates the relative movement between the carrier rod and the spiral spring.

In the case of a single spiral spring, the sleeve or the rotating carrier rod is preferably guided along the spiral spring in the latter's longitudinal direction. The follower device is then movable along the spiral spring, and in addition can be swivelled relative to the spring via the sleeve or the rotating carrier rod. At the same time, the follower device is guided along the spiral spring, via the sleeve or the rotating rod, in such a way that it deflects the spring both at positive and negative tilt angles of the camera.

### BRIEF DESCRIPTION OF THE DRAWINGS

Exemplary embodiments of the invention will now be described in more detail with reference to the enclosed drawings.

In particular:

FIG. 1 shows a schematic view of the forces and moments acting in a first to third embodiment,

FIG. 2 shows a first embodiment of the invention's camera tripod head in perspective view,

FIG. 3 shows a front view of a second embodiment of the invention's camera tripod head,

FIG. 4 shows a cross-section along the line A-A in FIG. 3,

FIG. 5 shows a cross-section through the first embodiment of the invention's camera tripod head in the deflected state,

FIG. 6 shows a third embodiment of the invention's camera tripod head with a damping device,

FIG. 7 shows a side view of a fourth embodiment of the invention's camera tripod head in two different positions, and

FIG. 8 shows a perspective view of the fourth embodiment in these two positions.

### DETAILED DESCRIPTION OF PREFERRED EMBODIMENTS OF THE INVENTION

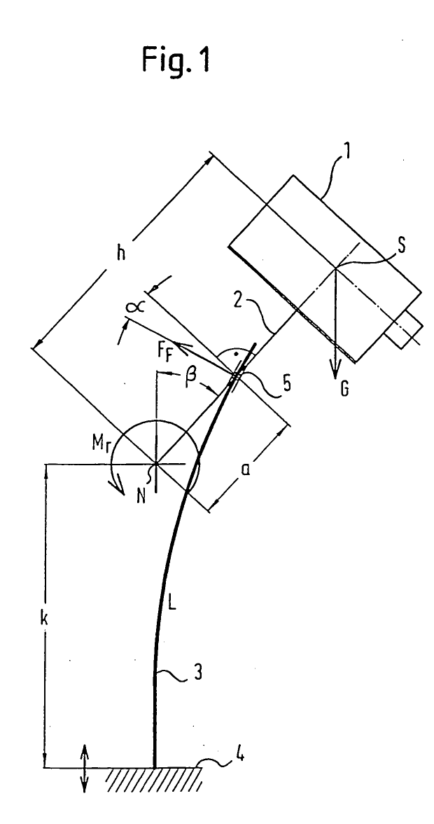

FIG. 1 illustrates the principle of the first to third embodiments of the invention, and shows schematically a camera system 1, mounted on a tiltable arrangement 2, which in turn is located on a base element 4 so as to be rotatable about a tilt axis N (normal to the plane of the diagram), where the connection between the base element 4 and the tiltable arrangement 2 is not shown for reasons of clarity. A spiral spring 3 is supported in the base element 4.

A follower device 5 is located on the tiltable arrangement 2, and the spiral spring 3 is connected to the tiltable arrangement 2 via this follower device 5. A sliding movement is possible between the follower device 5 and the spiral spring 3.

In addition, FIG. 1 illustrates the forces and moments acting in the system. The camera system 1 is displaced by the tilt angle β from its equilibrium position, in which its centre of gravity S lies exactly vertically above the tilt axis N that is normal to the plane of the diagram. Due to the distance h between the camera's centre of gravity and the tilt axis N, the effective lever arm h sin β together with the camera's weight G generates a tilt moment MN about the tilt axis N. The tilt moment MN=G h sin β increases sinusoidally with increasing angle β.

The restoring moment Mr generated by the spiral spring 3, results from the lever arm a that corresponds to the distance of the tilt axis N from the contact point between the follower device 5 and the tiltable arrangement 2. The elastic force Fr of the spiral spring 3 is a function of the sine of the tilt angle β, such that a restoring moment is generated which just like the tilt moment MN is sinusoidal. Appropriate choice of the spring constants and of the lever arm a produces a restoring moment Mr that compensates for the tilt moment MN. Furthermore, by adjusting the effective spring length L, the restoring moment can be adjusted exactly for a given camera weight G and a centre of gravity height h, so as to compensate exactly for the tilt moment MN that results from any tilt position of the camera.

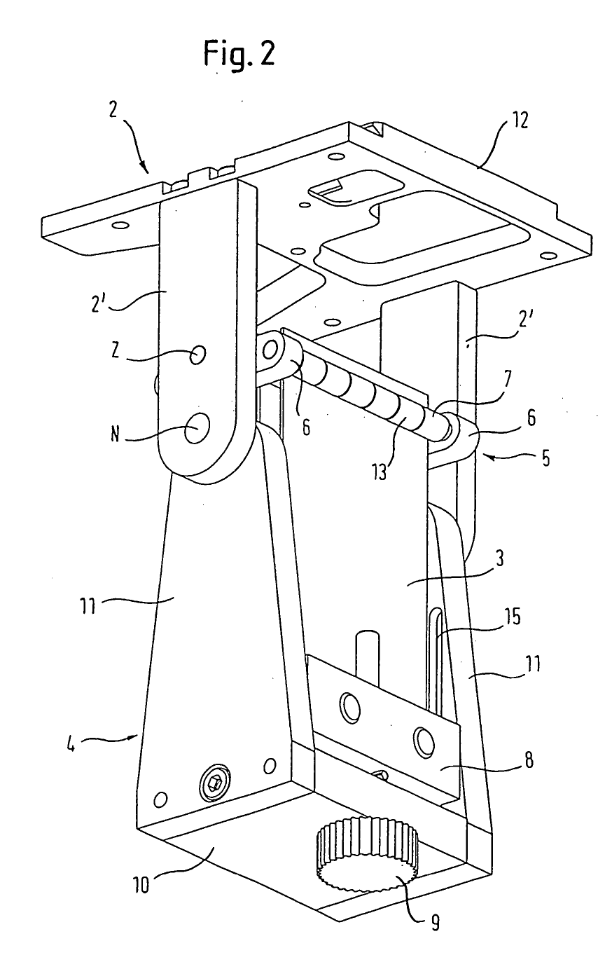

FIG. 2 shows a first preferred embodiment of the invention's camera tripod head. The base element 4 consists here of a base plate 10 and two pillar arms 11. Two tilt legs 2′ are attached to both pillar arms so as to be rotatable about a tilt axis N and carry a carrier element 12, on which various cameras, teleprompters, spotlights and the like (not shown) can be mounted.

An arrangement of spiral spring plates 3, acting in conjunction with a follower device 5, serves to compensate for the tilt moment generated when the carrier element 12 and a camera mounted on it are tilted about the tilt axis N. The spiral spring plates 3 are clamped at their lower end to the base element 4 via an adjusting device. The adjusting device contains a sliding element 8 that can be shifted vertically relative to base element 4 via an adjusting screw 9, as a result of which the contact point between the follower device 5 and the spiral spring plates 3 shifts, thus changing the effective length of the spiral spring plates 3. Two guiding grooves 15 serve to guide the sliding element 8 of the adjusting device relative to base element 4.

At their upper end, the spiral spring plates 3 are in contact with followers 7 of the follower device 5. These followers 7 are connected to the tilt legs 2′ via two carrier elements 6, with carrier elements 6 being able to rotate relative to the tilt legs 2′ about an axis Z that is parallel to the tilt axis N. The distance between the tilt axis N and axis Z corresponds to the lever arm a mentioned above, which is non-adjustable in this embodiment.

If the tilt legs 2′ and thus also the camera system are now tilt about the tilt axis N, this movement is transmitted by the tilt legs 2′ via carrier elements 6 and followers 7 to the spiral spring plates 3. In order to keep friction between the followers 7 and the spiral spring plates 3 to a minimum, the followers 7 are surrounded by rollers 13, which in the case of relative movement between the followers 7 and the spiral spring plates 3 roll over the spiral spring plates 3.

The camera system's tilt movement is not completely transmitted to the spiral spring plates 3, since the carrier elements 6 can rotate relative to the tilt legs 2′. Due to this relative rotation between the carrier elements 6 and the tilt legs 2′, the restoring forces of the spiral spring plates 3 always act normally to the followers 7, which prevents the system jamming.

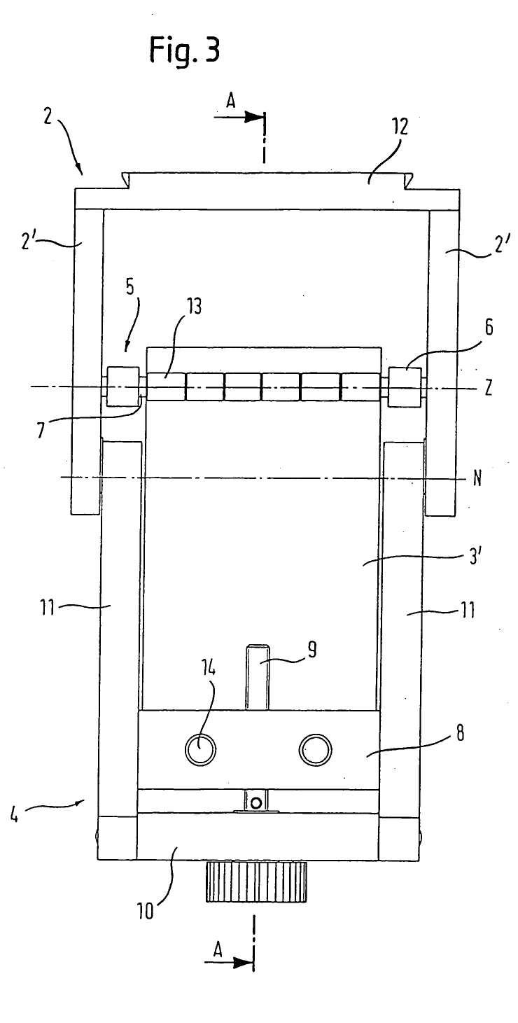

FIG. 3 is a front view of a second embodiment of the invention's camera tripod head. In contrast to the tripod head shown in FIG. 2, this second embodiment employs spring stacks 3′ made of spiral spring plates instead of individual spiral spring plates 3, which aspect is however not yet evident from FIG. 3. Otherwise, the second embodiment corresponds with the first one, and FIG. 3 shows even more clearly how the spiral spring stacks 3′ are connected to base element 4 via the sliding element 8 and the adjusting screw 9 of the adjusting arrangement. The spiral spring stacks 3′ are clamped into the sliding element via screws 14. In addition, the diagram shows the construction of the follower device 5, consisting of carrier elements 6, followers 7 and rollers 13 arranged around the latter.

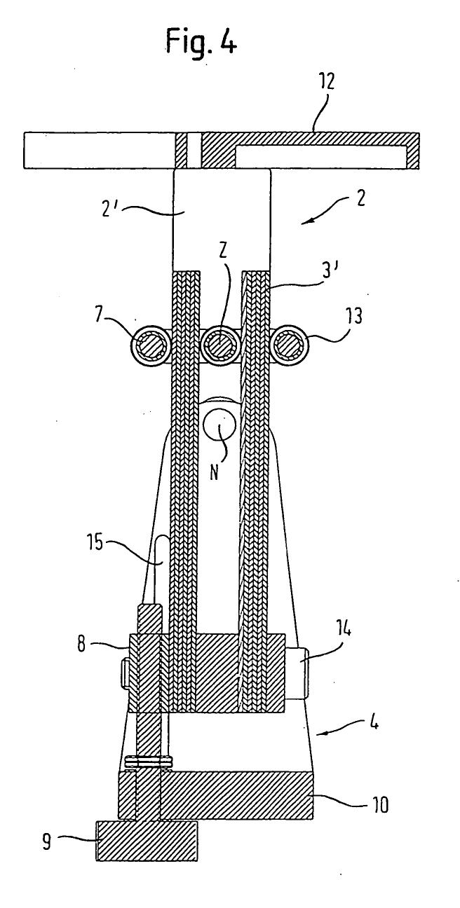

The cross-section in FIG. 4 shows the spiral spring stacks 3′ employed in the second embodiment. As described above, using spiral spring stacks 3′ instead of individual spiral springs 3 offers the advantage that the spiral springs can be shorter and still provide the desired restoring force.

FIG. 4 also shows that the spiral spring stacks 3′ are in contact with the three rollers 13, such that free play is avoided in the rest position. It is even preferable for the central roller of rollers 13 to apply a small pre-tensioning force on the spiral spring stacks 3′ in the rest position.

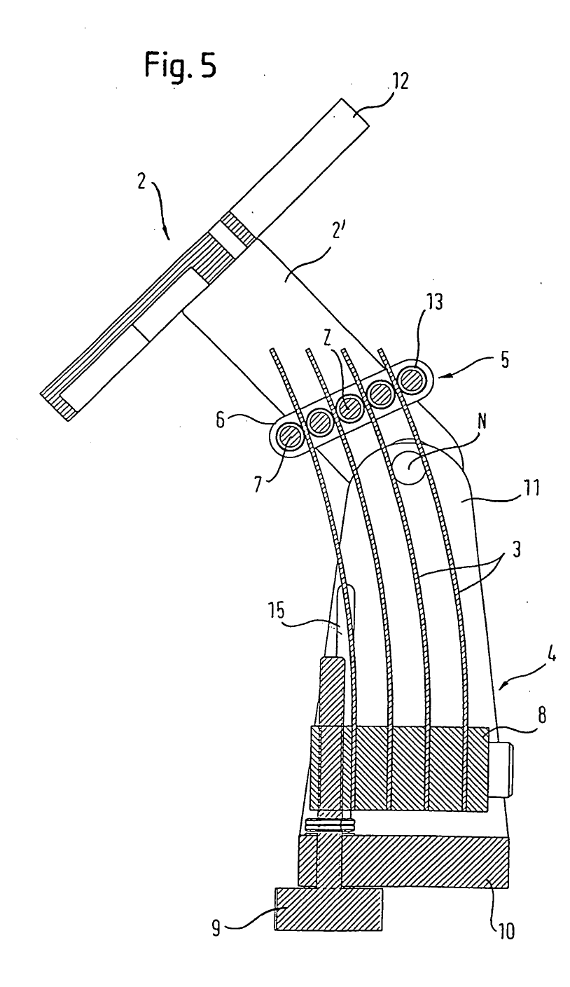

FIG. 5 shows a cross-section through the invention's first embodiment as illustrated in FIG. 2, in which four individual spiral spring plates 3 are each located between two followers 7. In FIG. 5, the tiltable arrangement 2 with the tilt legs 2′ is tilted about the tilt axis N, and it is evident how the carrier element 6 of the follower device rotates relative to the tilt legs 2′ during this tilt movement. The result of this relative rotation is that the spiral spring plates 3 do not completely follow the tilting movement of tilt legs 2′, and therefore are not strained beyond the permissible limit.

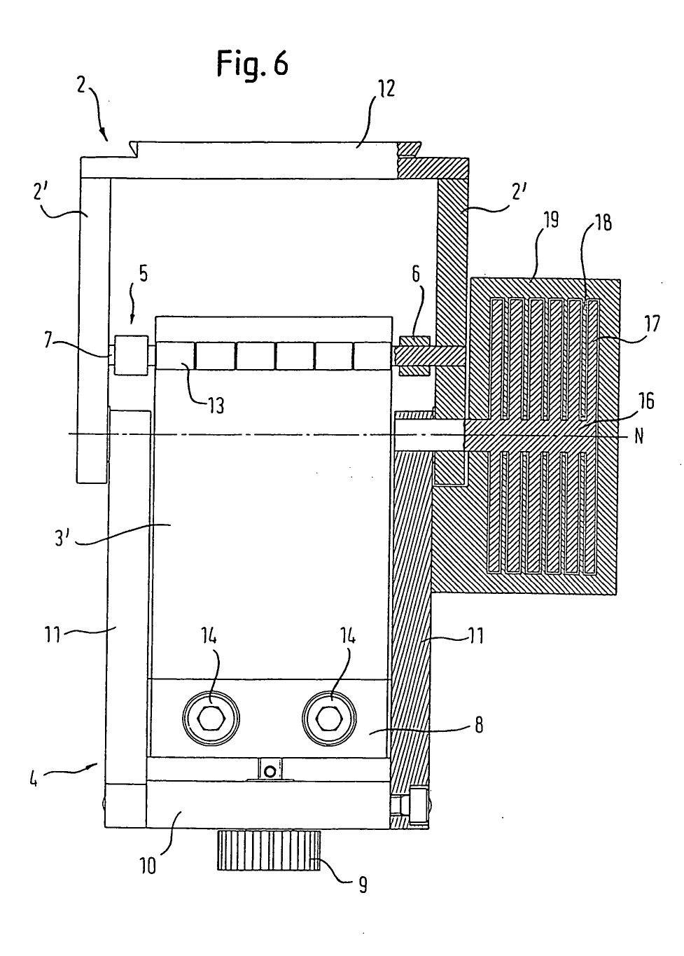

FIG. 6 shows a third embodiment of the invention's camera tripod head, which is provided with an arrangement for damping the tilting movement. To a shaft 16, whose axis coincides with the system's tilt axis N, are attached first annular discs 17, which in this embodiment are moulded integrally with the shaft 16. Between each two first annular discs 17 is located a second annular disc 18, where in this embodiment the second annular discs 18 are moulded integrally with a damping housing 19. A damping medium is present between the first annular discs 17 and the second annular discs 18.

Alternatively, the second annular discs 18 can mesh at their outer perimeter with a coupling element (not shown). This coupling element makes it possible to lock an arbitrary number of the second annular discs 18 to the housing, i.e. to prevent their rotation. The relative motion of the annular discs 17 generates a hydraulic damping force, with the degree of damping being adjustable by way of the number of annular discs locked to the housing.

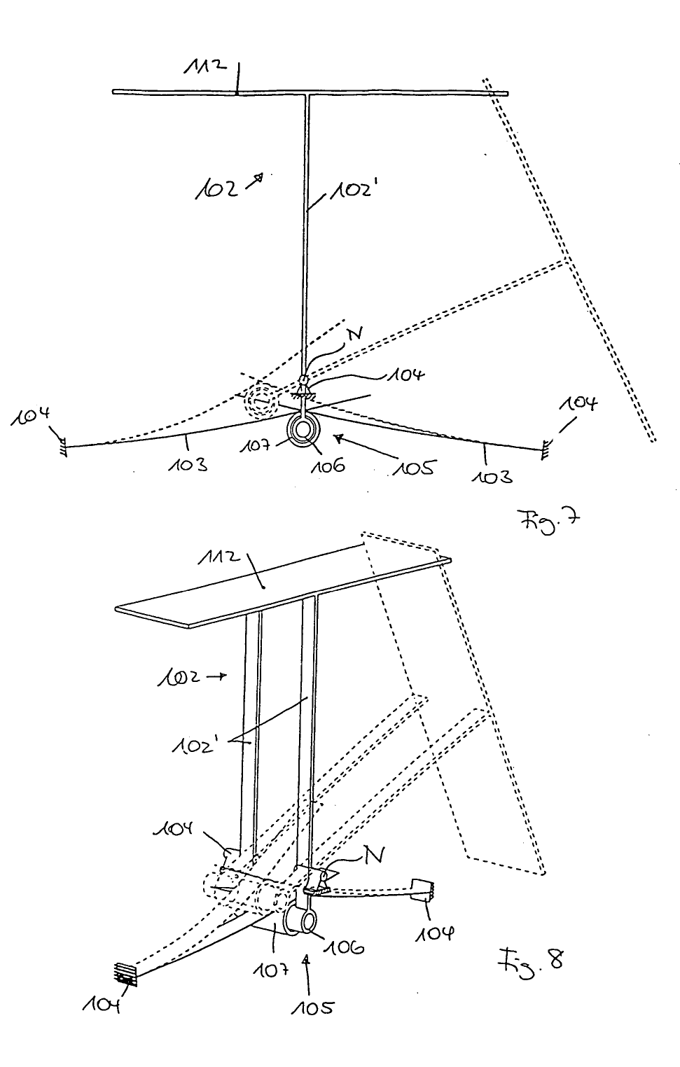

FIGS. 7 and 8 show a fourth embodiment of the invention. Instead of the carrier element 6 being able to rotate at its point of attachment to the tiltable arrangement 2, here the follower device 105 has a carrier rod 106 of circular cross-section, rigidly attached to the tiltable arrangement 102. A sleeve 107 can rotate about the carrier rod 106.

In the fourth embodiment as per FIGS. 7 and 8 there are two spiral springs 103, each clamped at one end to the base element 104 and with their other end lying on the rotatable sleeve 107 of the follower device 105. At a tilt angle of 0° (shown in FIGS. 7 and 8 in solid lines), the two spiral springs 103 are arranged at equal angles as mirror images of each other relative to a plane running vertically through the tilt axis N. When the camera system is displaced (shown in FIGS. 7 and 8 in dashed lines), the sleeve 107 of the follower device 105 rolls over the spiral springs 103 and deflects one spiral spring 103 (shown on the left in the diagram) strongly against the direction of tilt, and the other (shown on the right in the diagram) less strongly in the direction of tilt.

Obviously in this embodiment too, the spiral springs 103 can be replaced by spiral spring stacks.

Finally, a fifth embodiment of the invention's weight compensation, not shown in the diagrams, only contains a single spiral spring or a single spiral spring stack. The arrangement of the fifth embodiment corresponds fundamentally to that shown in FIG. 7, with the difference that it does without the second spiral spring shown on the right in FIG. 7. In order for the spiral spring nevertheless to apply a restoring moment to the camera system both in the case of positive and negative tilts of the camera, in this embodiment it is necessary to provide a guiding element between the follower device and the single spiral spring. In the fifth embodiment, this guiding element is implemented at the sleeve, which in turn can rotate around the carrier rod. The spiral spring is so arranged relative to the sleeve that the sleeve can move along the spring in the latter's longitudinal direction. Since the sleeve can also rotate relative to the carrier rod, the follower device can move relative to the single spiral spring without any difficulty and deflect the spring both at positive and negative tilt angles of the camera, without the system jamming.

1. Camera tripod head with:
a base element (4),
a tiltable arrangement (2), which on the one hand is attached to the base element (4) so as to be rotatable about a tilt axis (N) and on the other hand can be rigidly attached to a camera system, and
a device for compensating for a tilt moment generated during the tilt movement, containing at least one spiral spring (3) that is supported at one of its ends against the base element (4), wherein
the device for compensating the tilt moment contains a follower device (5), which is located on the tiltable arrangement (2) at a point some distance from the tilt axis (N) and which during the camera system's tilting movement deflects the spiral spring (3) in the direction of tilt, and the spiral spring (3) applies via the follower device (5) an essentially sinusoidal restoring moment on the tiltable arrangement (2) and thus on the camera system.

2. Camera tripod head according to as per claim 1,
wherein the follower device (5) is located on the tiltable arrangement (2) so as to be rotatable about an axis (Z), this axis being essentially parallel to the tilt axis (N).

3. Camera tripod head according to claim 1 wherein the follower device (5) consists of at least one carrier element (6) connected with the tiltable arrangement (2) so as to be rotatable and at least one follower (7).

4. Camera tripod head according to claim 3, wherein at least two followers (7) are provided the followers (7) are arranged in front and behind the spiral spring (3) in the tilt direction.

5. Camera tripod head according to claim 3 wherein the follower or followers (7) is or are designated in the form of a rod or rods.

6. Camera tripod head according to claim 3, wherein the follower or followers (7) is or are provided with friction-reducing elements, in particular rollers (13) or ball bearings, so that the follower or followers (7) moves or move against the spiral spring (3) with reduced friction when the camera is tilted.

7. Camera tripod head with:
a base element (104),
a tiltable arrangement (102), which on the one hand is attached to the base element (104) so as to be rotatable about a tilt axis (N) and on the other hand can be rigidly attached to a camera system, and
a device for compensating for a tilt moment generated during the tilt movement, containing at least one spiral spring (103) that is supported at one of its ends against the base element (104),
wherein
the device for compensating the tilt moment contains a follower device (105), which is located on the tiltable arrangement (102) at a point some distance from the tilt axis (N) and which during the camera system's tilting movement deflects at least one of the spiral springs (3) in the direction of tilt, and the at least one spiral spring (3) applies via the follower device (105) an essentially sinusoidal restoring moment on the tiltable arrangement (102) and thus on the camera system.

8. Camera tripod head according to claim 7, wherein two spiral springs (103) are provided, which at a tilt angle of 0° are arranged at equal angles as mirror images of each other relative to a plane running vertically through the tilt axis.

9. Camera tripod head according to claim 8, wherein when the camera is tilted, one spiral spring (103) is deflected against the direction of tilt whilst the other spiral spring (103) is deflected in the direction of tilt.

10. Camera tripod head according to claim 7, wherein exactly one spiral spring (103) is provided and the follower device (105) is so located that it is movable in the longitudinal direction of the spiral spring (103) and deflects the spiral spring (103) both in the case of positive and of negative tilt angles of the camera.

11. Camera tripod head according to claim 7, wherein the follower device (105) contains a carrier rod (106) rigidly connected to the tiltable arrangement (102).

12. Camera tripod head according to claim 7, wherein the follower device (105) contains a carrier rod (106) that is rotatable about its longitudinal axis relative to the tiltable arrangement (102).

13. Camera tripod head according to claim 11 wherein the follower device (105) contains in addition a rotatable sleeve arranged around the carrier rod (106), and during the camera systems's tilting movement the sleeve rolls over at least one spiral spring (103).

14. Camera tripod head according to claim 1 wherein the follower device (5; 105) is movable relative to the spiral springs (3; 103) during the camera's tilting movement.

15. Camera tripod head according to claim 1 wherein the tiltable arrangement (2; 102) contains at least one tilt leg (2′; 102′) and one carrier plate (12; 112).

16. Camera tripod head according to claim 15, wherein the tiltable arrangement (2; 102) contains at least two tilt legs (2′; 102′) arranged parallel to each other.

17. Camera tripod head according to claim 1 wherein the spiral spring (3; 103) is formed as a spiral spring plate (3; 103).

18. Camera tripod head according to claim 17, wherein the spiral spring plate (3;103) is designed in the shape of a rectangle, trapezoid or triangle.

19. Camera tripod head according to claim 17 wherein the spiral spring plate (3;103) has cut-outs such as e.g., holes punched in the material.

20. Camera tripod head according to claim 1 wherein the spiral spring plate (3;103) lies in a plane parallel to the tilt axis (N), when the tilt angle is 0°.

21. Camera tripod head according to claim 1 wherein several springs (3; 103) are provided.

22. Camera tripod head according to claim 1 wherein one follower (7) is arranged between every two spiral springs (3; 103).

23. Camera tripod head according to claim 1 wherein at least one spiral spring (3;103) is replaced by a spiral spring stack (3′).

24. Camera tripod head according to claim 1 wherein in addition an adjusting device (8, 9) is provided, by way of which the effective length (L) of the spiral spring (3, 3′; 103) can be changed.

25. Camera tripod head according to claim 24, wherein the effective spring length (L) can be continuously adjusted.

26. Camera tripod head according to claim 1 wherein the distance (a) between the tilt axis (N) and the connecting point of the tiltable arrangement (2; 102) and the following device (5; 105) is adjustable.

27. Camera tripod head according to claim 1 wherein the spiral spring (3, 3′; 103) is so arranged relative to the base element (4; 104) and the follower device (5; 105) that it is subjected to a small pre-tensioning force when the tilt angle is 0°.

28. Camera tripod head according to claim 1 wherein the spiral spring (3, 3′; 103) is under nearly its maximum permissible strain when the tilt angle is 0°.

29. Camera tripod head according to claim 1 wherein the spiral spring (3, 3′; 103) is made of carbon fibres, steel or glass fibres or a combination of materials.

30. Camera tripod head according to claim 1 wherein in addition a device (16, 17, 18, 19) for damping the tilt movement is provided.

31. Camera tripod head according to claim 1 wherein at least one spiral spring (3, 3′; 103) is designed as a solid body.

32. Camera tripod head according to claim 1 wherein at least one spiral spring (3, 3′; 103) is designed as a hollow body.
